(19) United States
(12) Patent Application Publication
(10) Pub. No.: US 2012/0246205 A1
(43) Pub. Date: Sep. 27, 2012

(54) EFFICIENT DATA STORAGE METHOD FOR MULTIPLE FILE CONTENTS

(75) Inventor: Yuichi TAGUCHI, San Jose, CA (US)

(73) Assignee: HITACHI, LTD., Tokyo (JP)

(21) Appl. No.: 13/069,847

(22) Filed: Mar. 23, 2011

(51) Int. Cl. G06F 17/30

(52) U.S. Cl. 707/822; 707/E17.01

(57) ABSTRACT

Embodiments of the invention provide efficient data storage for multiple file contents. In specific embodiments, a content management computer is coupled via a network to a storage system, and comprises a processor, a memory, and a content compose/decompose module. The content compose/decompose module is configured to: decompose a file into multiple parts of data and store the multiple parts into adaptive logical storage partitions; and in response to a read request for the file, re-compose the multiple parts into an original file and send the original file. The file is decomposed into the multiple parts based on both structure and characteristics of the data in the file. The multiple parts are stored into different media provided by the adaptive logical storage partitions according to the structure and characteristics of the data in the multiple parts.

### BACKGROUND OF THE INVENTION

The present invention relates generally to storage systems and, more particularly, efficient data storage for multiple file contents.

The amount of storage capacity is rapidly increasing for enterprise IT (Information Technology) systems. This makes it difficult to keep better efficiency in storage capacity usage. For example, there are several different types of storage media today. Solid state disk (SSD) is very expensive but possesses high performance and small capacity (in GB). SATA HDD is cheaper and has low performance but large capacity. The enterprise IT administrator must consider how to utilize these different types of media by storage tier. On the other hand, there are data management applications such as PACS for medical purposes. PACS handles its data by DICOM (Digital Imagining and Communications in Medicine) file formatting. Each DICOM file contains multiple individual files therein. In addition to traditional image files, audio and movie files can be contained in the DICOM file.

To improve storage efficiency, it is better to store different types of data utilizing an adaptive storage tier. For example, audio and movie data can be loaded through the period of viewing in parallel. In the case where this assumption works, audio and movie data should be stored in a lower tier, since they do not require high performance. However, DICOM is a format to converge entire data into a single file, so that it is impossible to utilize multiple tiers of storage.

Furthermore, there is a situation to run a data analysis that loads all of the data stored. Virus scanning and file system scan are simple examples. On the other hand, it is also possible to have a situation to run a statistical analysis that reads the large number of files to count and calculate for special purposes. In this case, it is common that the file header is checked to find a particular information such as, for instance, the age of patient visit in the season or special case of patients to be surveyed, and so on. To execute this type of analysis, performance is a problem because it has to load a large amount of files.

### BRIEF SUMMARY OF THE INVENTION

Exemplary embodiments of the invention provide efficient data storage for multiple file contents. In specific embodiments, a content management server computer decomposes parts of a file and stores them into adaptive storage tier in order to improve capacity efficiency. In one embodiment, the content management server computer also divides the header and body of the file and stores the header in a higher performance storage media than the body in order to improve performance.

An aspect of the present invention is directed to a content management computer coupled via a network to a storage system, the content management computer comprising a processor, a memory, and a content compose/decompose module. The content compose/decompose module is configured to: decompose a file into multiple parts of data and store the multiple parts into adaptive logical storage partitions; and in response to a read request for the file, re-compose the multiple parts into an original file and send the original file. The file is decomposed into the multiple parts based on both structure and characteristics of the data in the file. The multiple parts are stored into different media provided by the adaptive logical storage partitions according to the structure and characteristics of the data in the multiple parts.

In some embodiments, the structure of the data includes a header and a body of the file, and the characteristics of the data include one or more of text data, image data, audio data, and video data. Decomposing a file comprises dividing the file into a header and a body. The header and the body are stored into different media, the header being stored into a higher performance media than the body. The content compose/decompose module is configured to determine locations to store the multiple parts that are decomposed; and the content compose/decompose module is configured to find locations of the multiple parts and load the multiple parts that are to be re-composed. A content compression module is configured to: find fragmented components from the multiple parts that are stored in the adaptive logical storage partitions; compress the fragmented components; store the compressed fragmented components; and update a header of the file based on the compressed fragmented components. A configuration management module is configured to detect logical units in the storage system and divide the detected logical units into smaller adaptive logical storage partitions for storing the decomposed multiple parts.

Another aspect of the invention is directed to an information system comprising a content management computer and a storage system which are coupled via a network, the content management computer including a processor, a memory, and a content compose/decompose module. The content compose/decompose module is configured to: decompose a file into multiple parts of data and store the multiple parts into adaptive logical storage partitions; and in response to a read request for the file, re-compose the multiple parts into an original file and send the original file. The file is decomposed into the multiple parts based on both structure and characteristics of the data in the file. The multiple parts are stored into different media provided by the adaptive logical storage partitions according to the structure and characteristics of the data in the multiple parts.

In some embodiments, a content server computer is coupled via the network to the content management computer, the content server computer being configured to merge a set of data from multiple files into a single file and transfer the single file to the content management computer as the file to the decomposed. The file is a DICOM file.

In accordance with another aspect of this invention, a content management method for a storage system comprises: decomposing a file into multiple parts of data and storing the multiple parts into adaptive logical storage partitions; and in response to a read request for the file, re-composing the multiple parts into an original file and send the original file. The file is decomposed into the multiple parts based on both structure and characteristics of the data in the file. The multiple parts are stored into different media provided by the adaptive logical storage partitions according to the structure and characteristics of the data in the multiple parts.

These and other features and advantages of the present invention will become apparent to those of ordinary skill in the art in view of the following detailed description of the specific embodiments.

### BRIEF DESCRIPTION OF THE DRAWINGS

FIG. 1 shows an example of a content store system according to an embodiment of the present invention.

FIG. 2 illustrates a logical relationship of storage resources between Content Management Server Computer and Data Storage.

FIG. 3 illustrates a logical flow of data over the content store system of FIG. 1.

FIG. 4 shows an example of a flow diagram illustrating a process of the logical flow of data of FIG. 3.

FIG. 5 shows an example of a hardware configuration of Data Storage.

FIG. 6 shows an example of a hardware configuration of Content Management Server Computer.

FIG. 7 shows an example of a hardware configuration of Content Server Computer.

FIG. 8 shows an example of a hardware configuration of Management Server Computer.

FIG. 9 shows an example of a hardware configuration of Storage Network Switch.

FIG. 10 shows an example of a hardware configuration of Local Area Network Switch.

FIG. 11 shows an example of a software configuration stored on the memory of Data Storage.

FIG. 12 shows an example of a software configuration stored on the memory of Content Management Server Computer.

FIG. 13 shows an example of a software configuration stored on the memory of Content Server Computer.

FIG. 14 shows an example of a software configuration stored on the memory of Management Server Computer.

FIG. 15 shows an example of a data structure of the LU Configuration Information of the Data Storage.

FIG. 16 shows an example of a data structure of the RAID Hardware Information of the Data Storage.

FIG. 17 shows an example of a data structure of the Local Storage Configuration Information of the Content Management Server Computer.

FIG. 18 shows an example of a data structure of the Content Composition Information of the Content Management Server Computer.

FIG. 19 shows additional information of the Content Composition Information of FIG. 18.

FIG. 20 shows an example of a data structure of the Content Control Policy Definition of the Management Server Computer.

FIG. 21 illustrates an example of content decompose process.

FIG. 22 illustrates an example of content compose process.

FIG. 23 shows an example of a flow diagram illustrating a process to generate a new content file.

FIG. 24 shows an example of a flow diagram illustrating a process to decompose and store a content file.

FIG. 25 shows an example of a flow diagram illustrating a process to load and compose a content file.

FIG. 26 shows an example of a data structure of File Header.

FIG. 27 shows an example of a flow diagram illustrating a process to compress data after it has been stored.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for efficient data storage for multiple file contents.

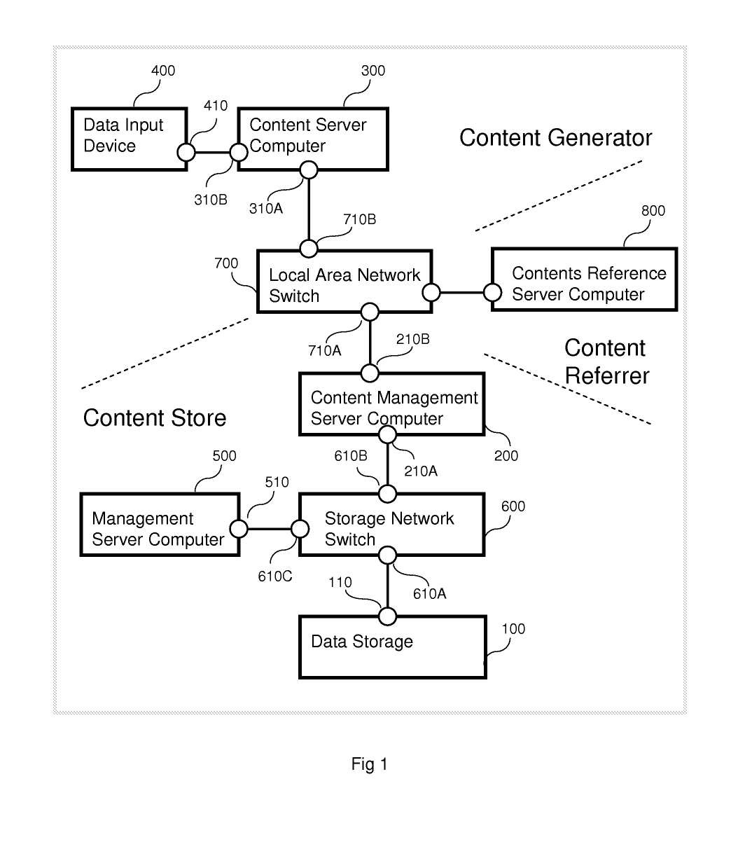

FIG. 1 shows an example of a content store system according to an embodiment of the present invention. A Content Server Computer 300 controls a Data Input Device 400 for capturing new data. The Content Server Computer 300, Content Reference Server Computer 800, and Content Management Server Computer 200 are interconnected through a Local Area Network Switch 700. The Local Area Network Switch 700 can be implemented by an Ethernet switch etc. The Content Management Server Computer 200 and Data Storage 100 are connected by a Storage Network Switch 600. In this embodiment, the Local Area Network 700 and Storage Network Switch 600 are described as individual switches separate from each other, but it is possible to implement them by a single network switch. A Management Server Computer 500 is connected to the Content Server Management Computer 200 and Data Storage 100 through the Storage Network Switch 600 or Local Area Network Switch 700.

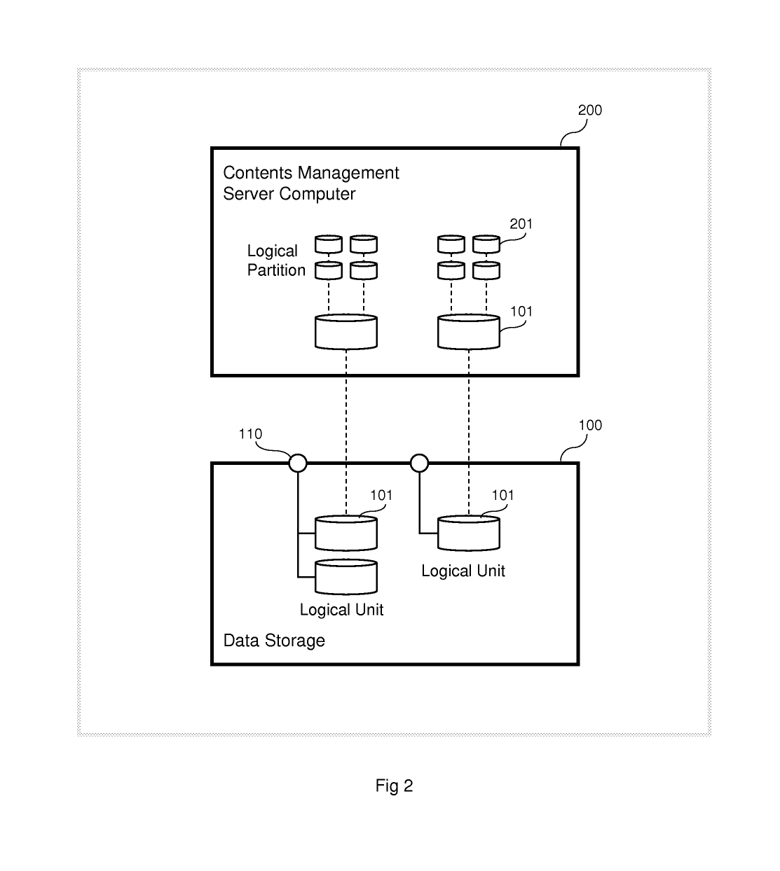

FIG. 2 illustrates a logical relationship of storage resources between the Content Management Server Computer 200 and Data Storage 100. A Logical Unit 101 is a part of storage resources equipped on the Data Storage 100. The Logical Unit 101 is accessible through a Network Interface 110. The Content Management Server Computer 200 detects the Logical Units 101 and it again divides them into smaller logical partitions 201, each of which is a component of data store utilized on file system running on the Content Management Server Computer 200.

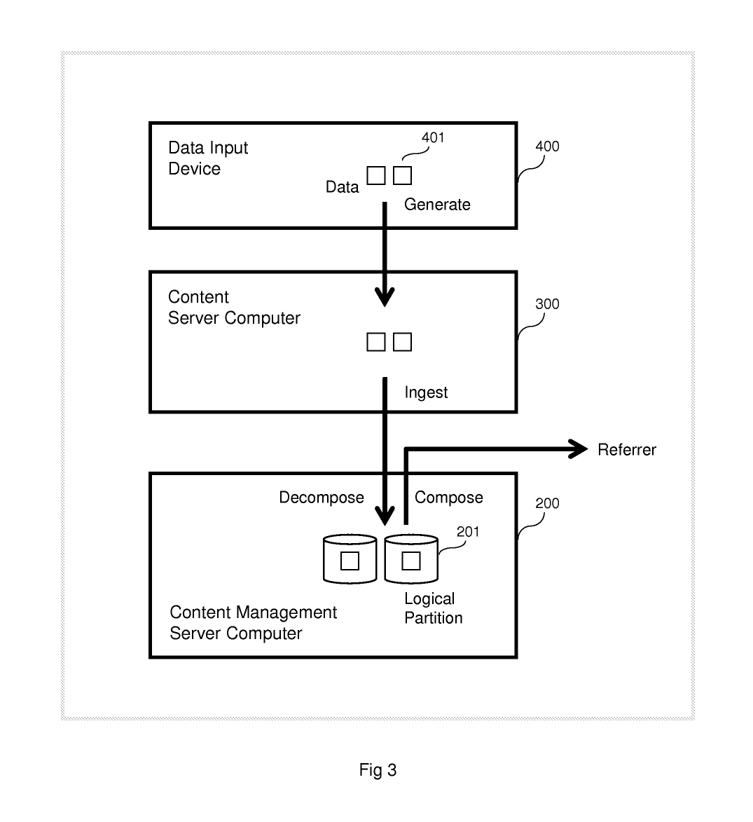

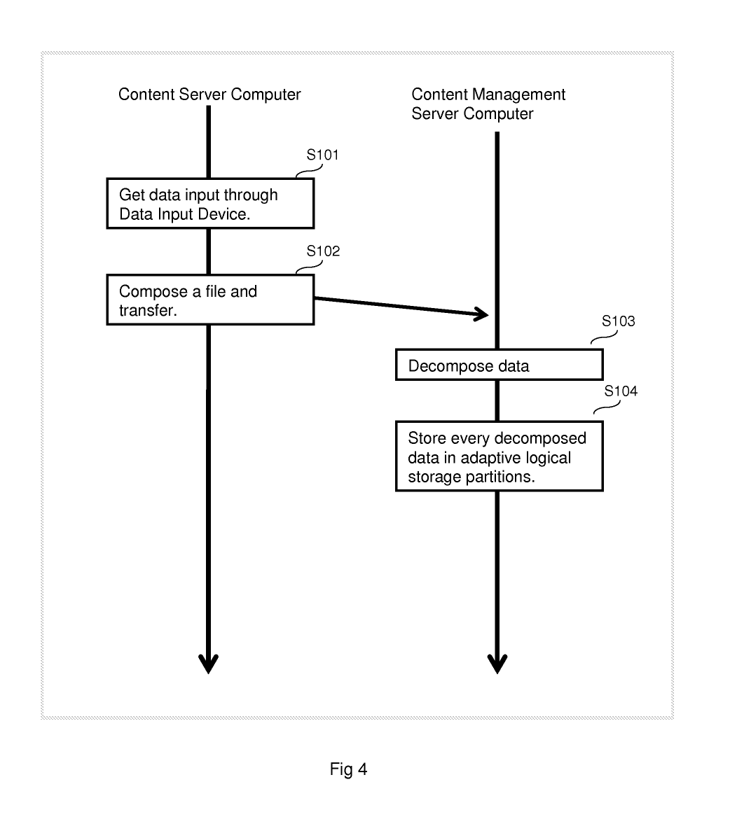

FIG. 3 illustrates a logical flow of data over the content store system of FIG. 1. FIG. 4 shows an example of a flow diagram illustrating a process of the logical flow of data of FIG. 3. The Data Input Device 400 captures one or more data parts. The Content Server Computer 300 temporarily stores them in a local memory (S101). After composing it as a single file, the Content Server Computer 300 ingests them into the Content Management Server Computer 200 (S102). The Content Management Server Computer 200 decomposes the file into multiple chunks of data (S103) and stores them in local partitions of adaptive storage type, i.e., adaptive logical storage partitions (S104). When the Data Reference Server Computer 800 requests to read them, the Content Management Server Computer 200 re-composes an original file and issues it in response to the request.

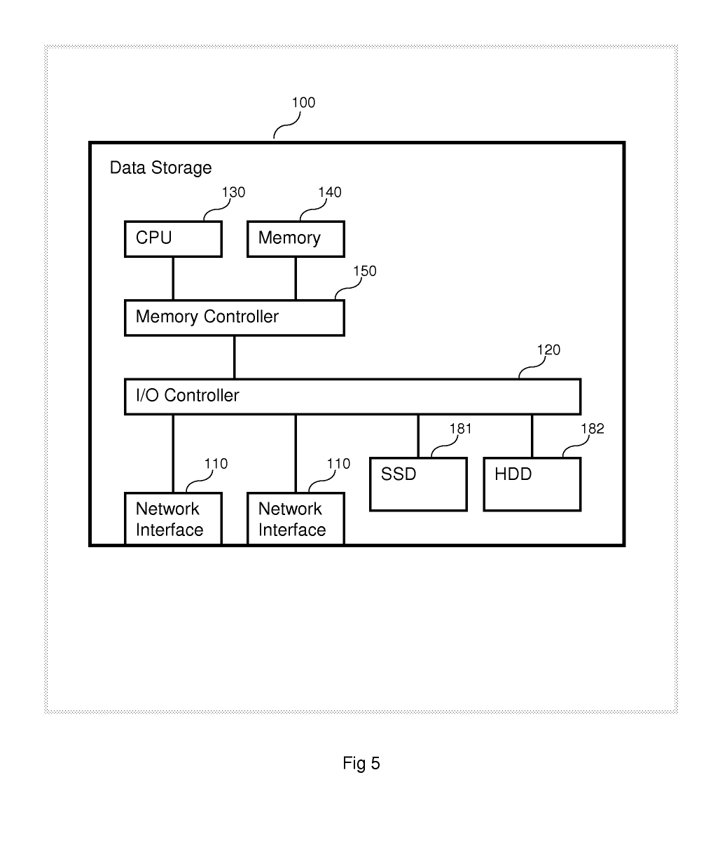

FIG. 5 shows an example of a hardware configuration of the Data Storage 100. The Data Storage 100 is equipped with one or more Network Interfaces 110, SSD 181 and HDD 182 that are connected by an I/O controller 120. It is obvious that other types of storage media can be installed than SSD and HDD. A CPU 130 and a Memory 140 are connected through a Memory Controller 150. As such, the Data Storage 100 is not only a bulk of storage media but it has a capability of calculation processing.

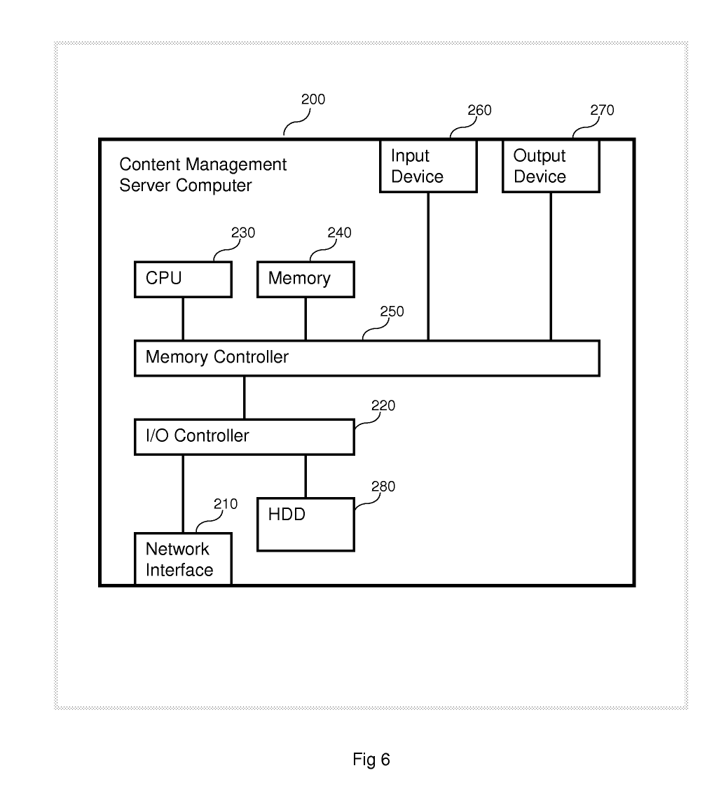

FIG. 6 shows an example of a hardware configuration of the Content Management Server Computer 200. A CPU 230, a Memory 240, an input device 260 (e.g., keyboard or mouse), and an output device 270 (e.g., video graphic card connected to external display monitor) are interconnected through a Memory Controller 250. All I/Os handled by an I/O controller 220 are processed on an internal HDD device 280 or an external storage device through a network interface 210. This configuration is possible to be implemented by a common, general, multi-purpose PC.

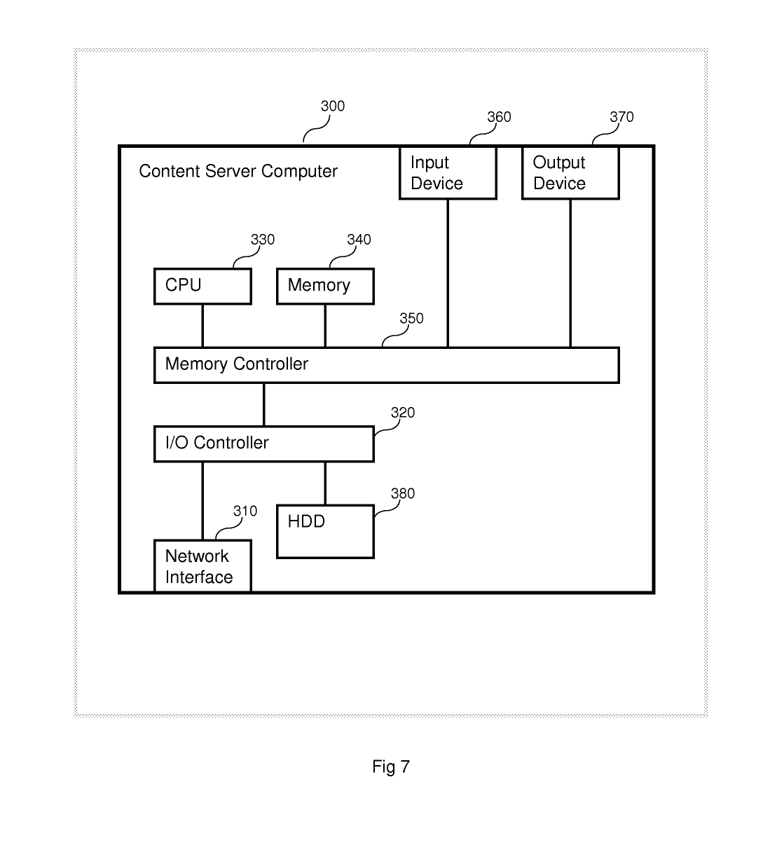

FIG. 7 shows an example of a hardware configuration of the Content Server Computer 300. A CPU 330, a Memory 340, an input device 360, and an output device 370 are interconnected through a Memory Controller 350. All I/Os handled by an I/O controller 320 are processed on an internal HDD device 380 or an external storage device through a network interface 310.

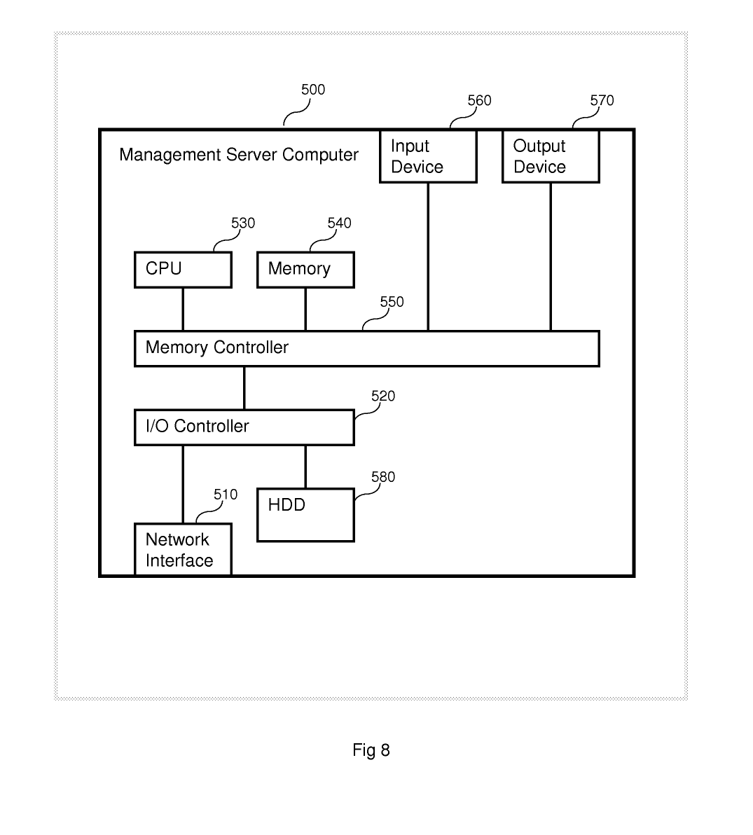

FIG. 8 shows an example of a hardware configuration of the Management Server Computer 500. A CPU 530, a Memory 540, an input device 560, and an output device 570 are interconnected through a Memory Controller 550. All I/Os handled by an I/O controller 520 are processed on an internal HDD device 580 or an external storage device through a network interface 510.

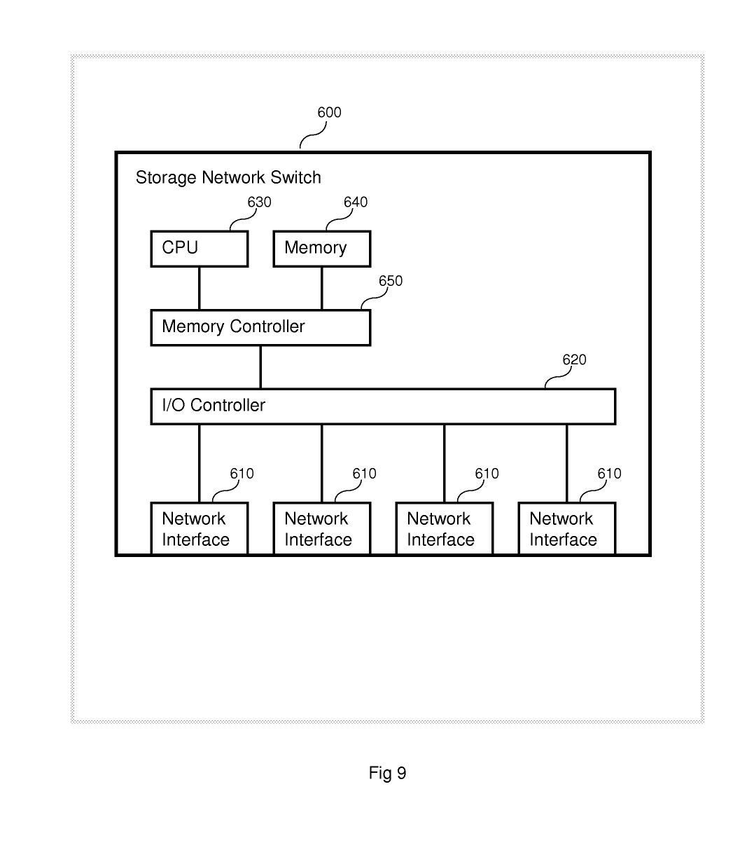

FIG. 9 shows an example of a hardware configuration of the Storage Network Switch 600. A plurality of network interfaces 610 are connected by an I/O controller 620. A CPU 630 and a Memory 640 are connected through a Memory Controller 650.

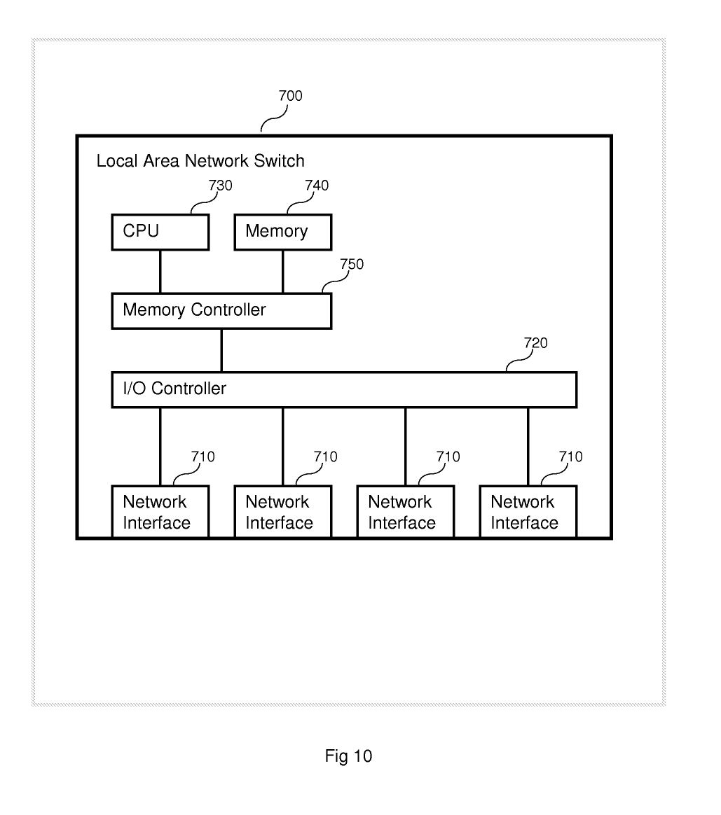

FIG. 10 shows an example of a hardware configuration of the Local Area Network Switch 700. A plurality of network interfaces 710 are connected by an I/O controller 720. A CPU 730 and a Memory 740 are connected through a Memory Controller 750.

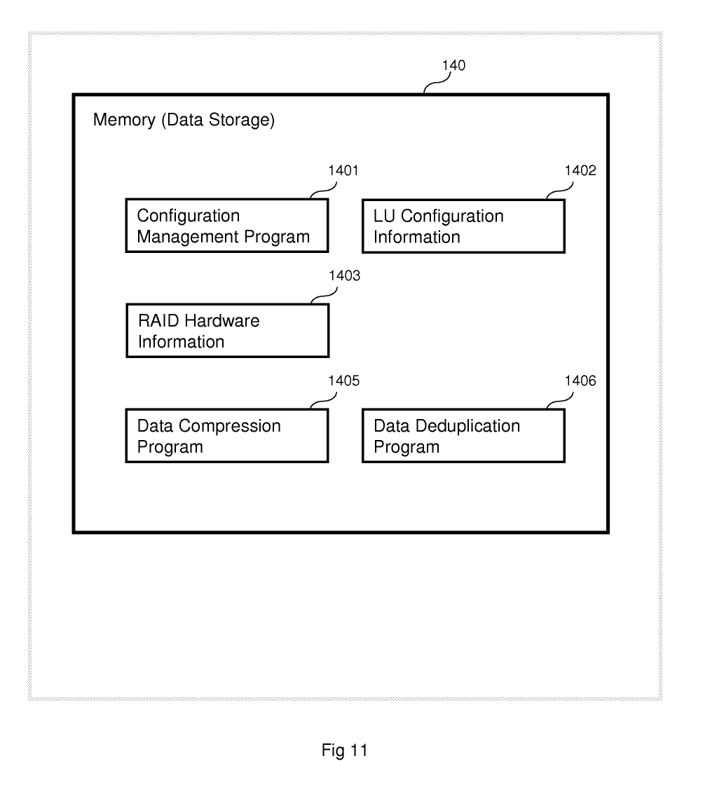

FIG. 11 shows an example of a software configuration stored on the memory 140 of the Data Storage 100. A Configuration Management Program 1401 controls deployment of the Logical Units 101. LU Configuration Information 1402 represents configuration of the Logical Units. RAID Hardware Information 1403 is a definition of RAID group that consists of a set of HDDs. A Data Compression Program 1405 and a Data Deduplication Program 1406 are programs that compress and de-duplicate data stored in the Logical Units 101, respectively.

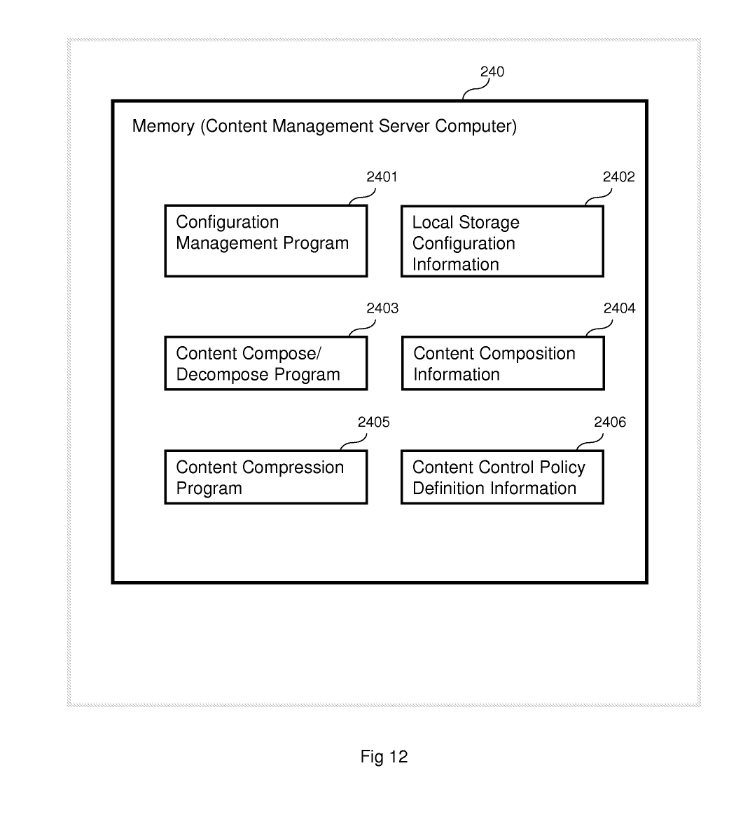

FIG. 12 shows an example of a software configuration stored on the memory 240 of the Content Management Server Computer 200. A Configuration Management Program 2401 controls deployment of local storage volume configuration. Local Storage Configuration Information 2402 represents configuration of logical storage volumes. A Content Compose/Decompose Program 2403 is a program to compose and de-compose files to store and load. Content Composition Information 2404 contains information of data structure and location of data parts stored. A Content Compression Program 2405 is a program to compress data file on the Content Management Server Computer 200. Content Control Policy Definition Information 2406 contains data loaded from the Management Server Computer 500.

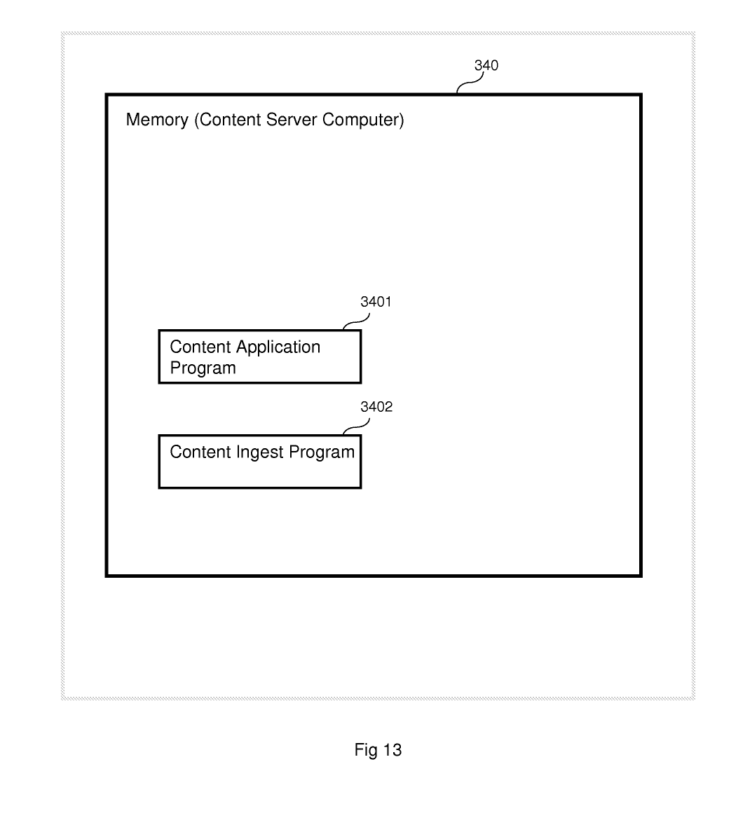

FIG. 13 shows an example of a software configuration stored on the memory 340 of the Content Server Computer 300. A Content Application Program 3401 is application software that generates new contents by controlling the Input Device 400. A Content Ingest Program 3402 submits data captured by the Content Application Program 3401.

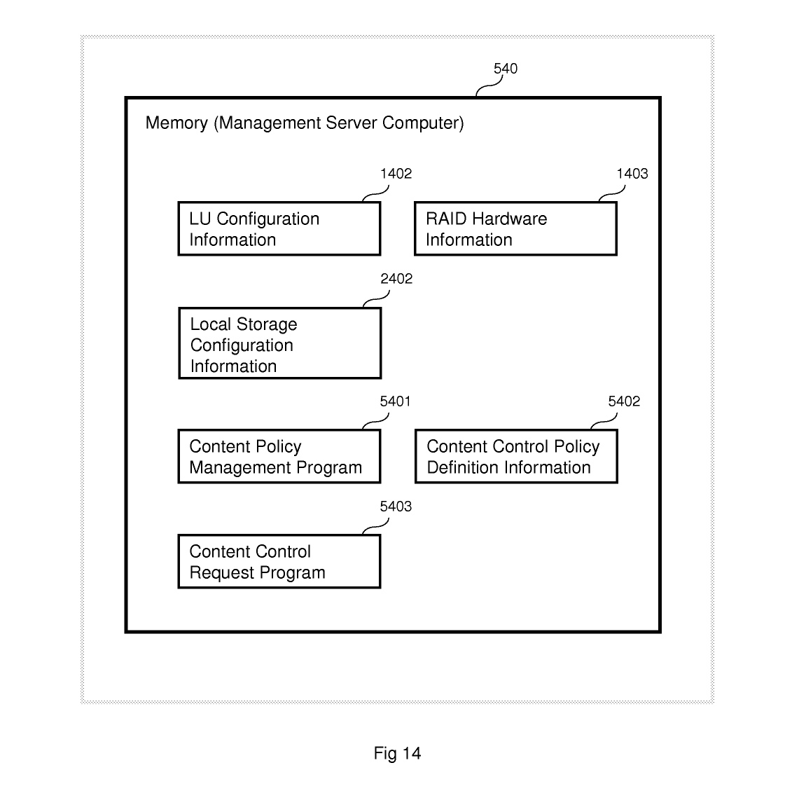

FIG. 14 shows an example of a software configuration stored on the memory 540 of the Management Server Computer 500. LU Configuration Information 1402 and RAID Hardware Information 1403 are transferred from the Data Storage 100. Local Storage Configuration Information 2402 is also transferred from the Content Management Server Computer 200. A Content Policy Management Program 5401 defines rules to store data by its type or attribute. Content Control Policy Definition Information 5402 is a definition of policy rule sets. A Content Control Request Program 5403 issues a request to set policy rules on the Content Management Server Computer 200 and Data Storage 100.

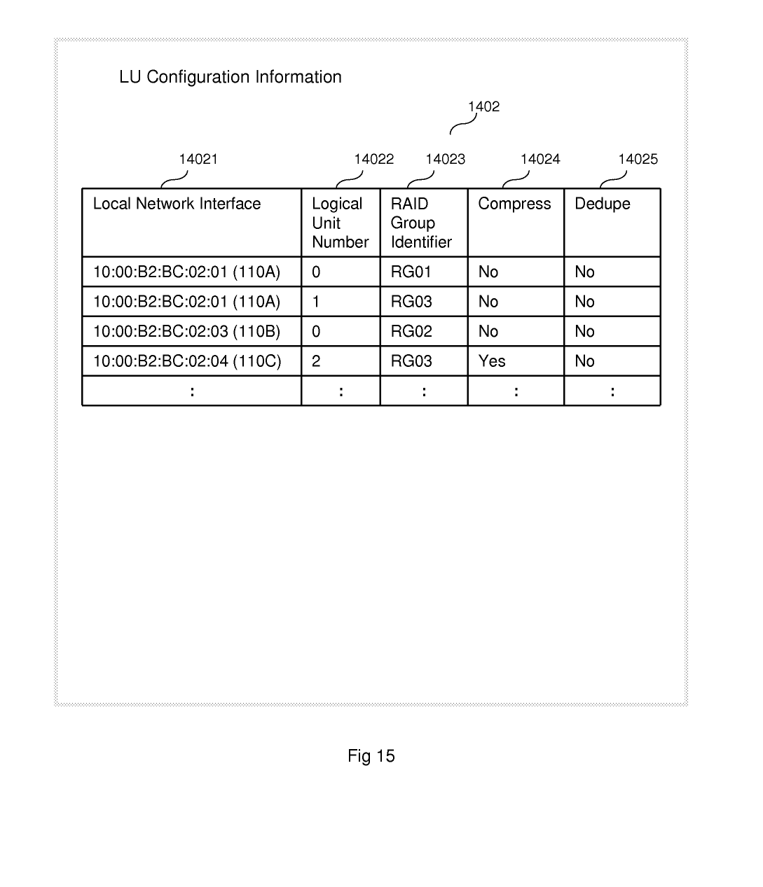

FIG. 15 shows an example of a data structure of the LU Configuration Information 1402 of the Data Storage 100. A logical unit is defined by a combination of Local Network Interface 14021, Logical Unit Number 14022, and RAID Group Identifier 14023. The Local Network Interface 14021 is a Network Interface 110 that is associated with one or more logical units. The Logical Unit Number 14022 identifies LUs that are defined on a single Network Interface 110. The RAID Group Identifier 14023 shows a RAID group that is configured on the RAID Hardware Information 1403. The LU is a part of resources assigned from one or more RAID groups. Compress Information 14024 and Dedupe Information 14025 are Boolean type parameters that define whether the Logical Unit is compressed or not, and deduplicated or not, respectively. If the Compress Information Boolean is defined as Yes, the Data Storage 100 runs the Data Compression Program 1405 for the Logical Unit. If the Dedupe Information Boolean is defined as Yes, the Data Storage 100 runs the Data Deduplication Program 1406 for the Logical Unit.

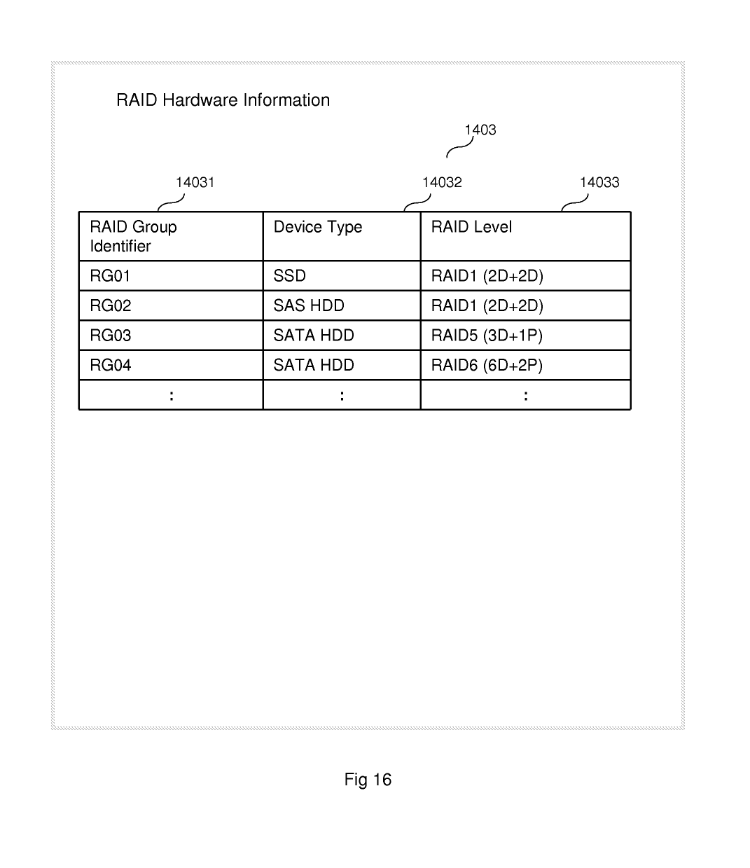

FIG. 16 shows an example of a data structure of the RAID Hardware Information 1403 of the Data Storage 100. A RAID Group defined by RAID Group Identifier 14031 is a set of SSDs or HDDs that provides RAID functionality. Device Type 14032 shows a type of disk drives. RAID Level 14033 defines how it configures RAID function.

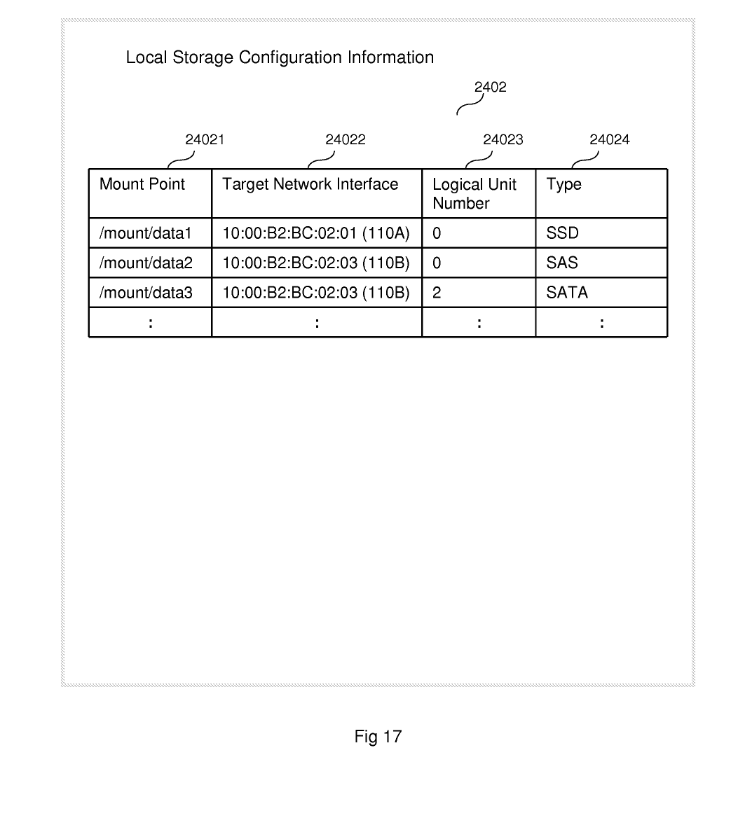

FIG. 17 shows an example of a data structure of the Local Storage Configuration Information 2402 of the Content Management Server Computer 200. Mount Point 2401 is a local point of file system that is running on the Content Management Server Computer 200. Target Network Interface 24022 is the Network Interface 110 installed on the Data Storage 100. Logical Unit Number 24023 is a logical unit that is defined on the Network Interface 110 which is listed on the Target Network Interface 24022. Type Information 24024 is storage type of LUs that can be recognized by the RAID Hardware Information 1403 and LU Configuration Information 1402. Any applications running on the Content Management Server Computer 200 can refer and store data from/to the Logical Unit of the Data Storage 100 by accessing mount points defined as the Mount Point 24021. For example, when the application program writes data into directory made under /mount/data1, data is sent to the Data Storage 100 and stored on Logical Unit “0” created on Network Interface “10:00:B2:BC:02:01.”

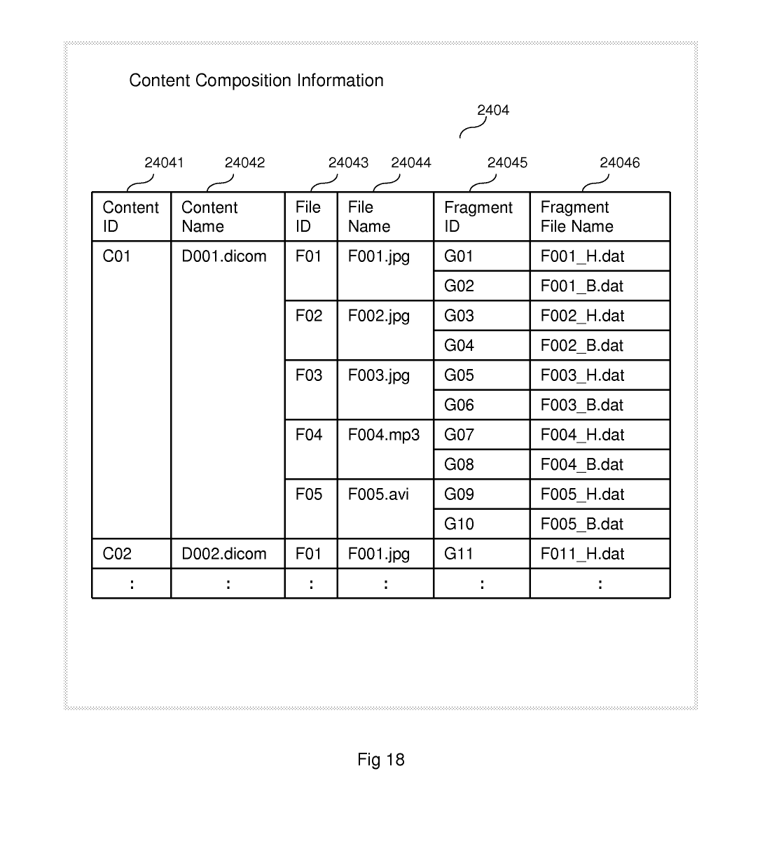

FIG. 18 shows an example of a data structure of the Content Composition Information 2404 of the Content Management Server Computer 200. A data file determined as Content ID 24041 and Content Name 24042 is divided to multiple sub files. A DICOM formatted file is a good example that consists of multiple file containers in it. A sub file is identified as a combination of File ID 24043 and File Name 24044. Also, a sub file can be divided by its header and body component. A set of Fragment ID 24045 and Fragment File Name 24046 defines the component. The Content Compose/Decompose Program 2403 divides a file before storing and merges it after loading.

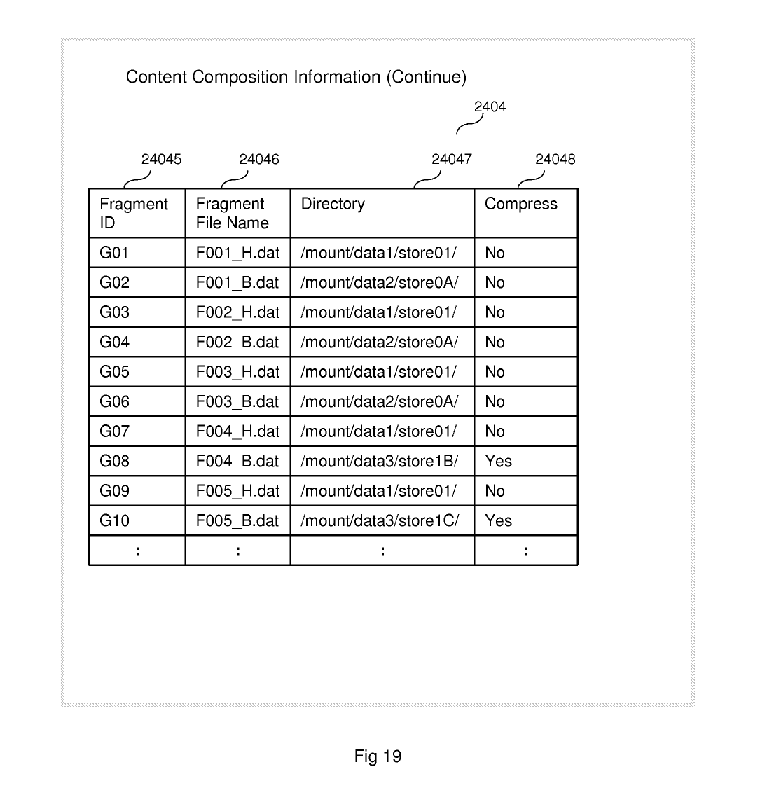

FIG. 19 shows additional information of the Content Composition Information 2404 of FIG. 18. The fragmented component is stored on Directory 24047, and it is compressed by the Data Compression Program 2405 when it is defined as “Yes” under Compress Information 24048.

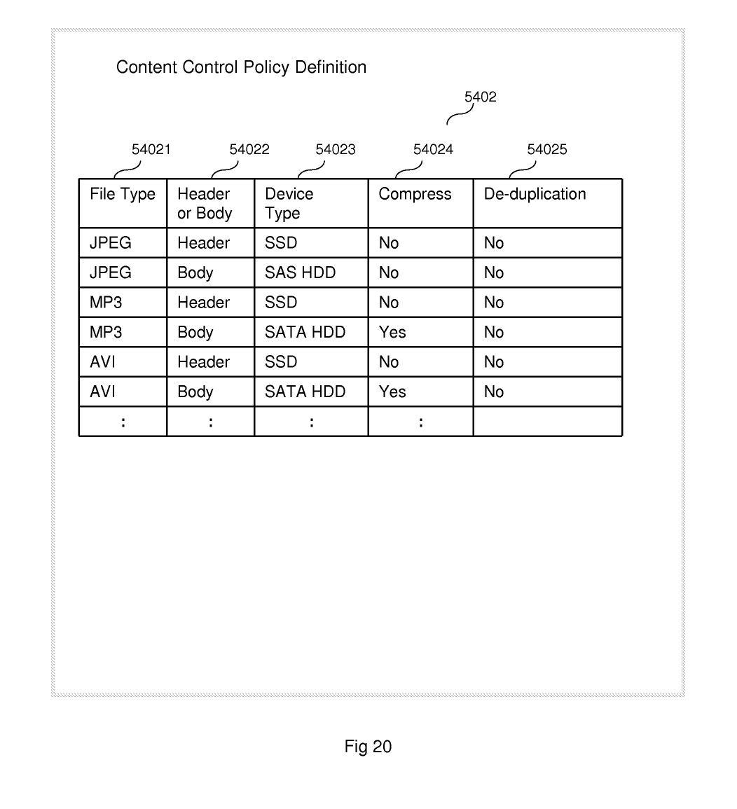

FIG. 20 shows an example of a data structure of the Content Control Policy Definition 5402 of the Management Server Computer 500. The content administrator can define content handling rules by its file type. The Content Control Policy Definition 5402 lists File Type 54021, Header or Body 54022, and Device Type 54023. For example, an image file “JPEG” that requires higher I/O performance can be defined as SAS HDD (Device Type). On the other hand, audio “MP3” and movie “AVI” that require higher capacity should be stored in large capacity media such as SATA HDD. Also, this system allows administrators to define header parts to be stored on the highest performance storage tier, SSD. Furthermore, these parts may be defined as Compress 54024 or De-duplication 54025.

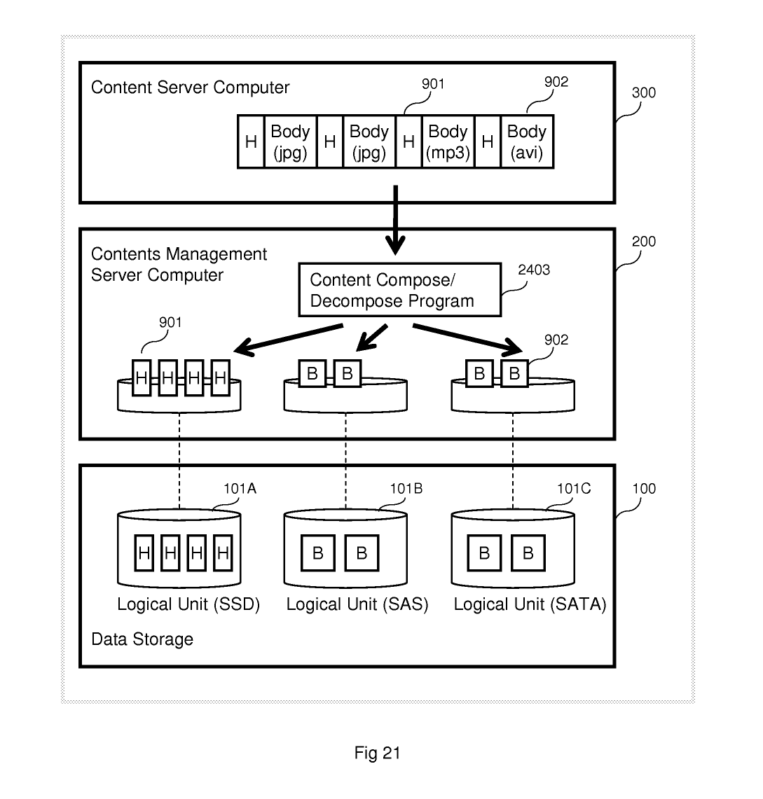

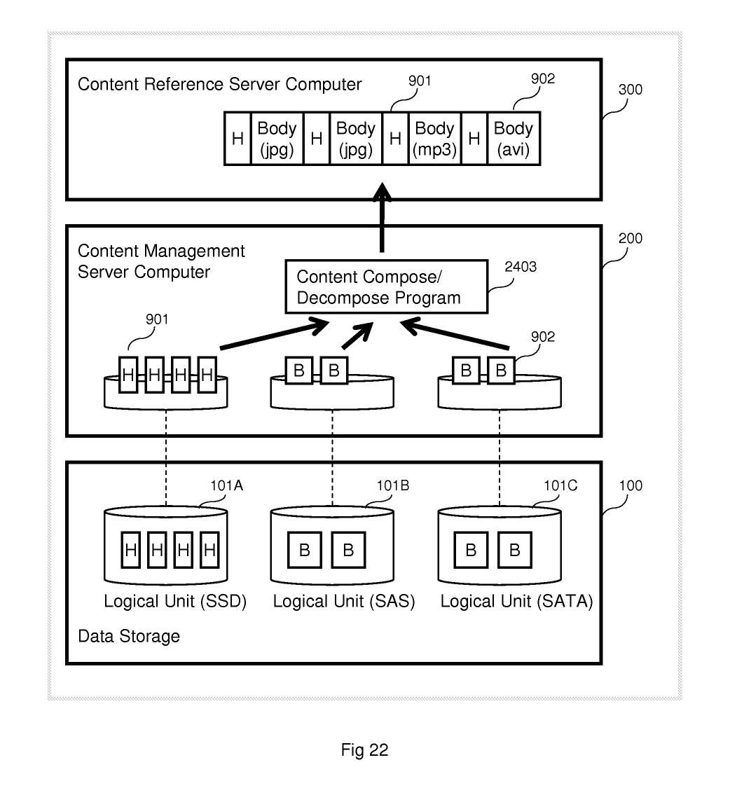

FIG. 21 and FIG. 22 illustrate an example of content compose and decompose processes. A content generated on the Content Server Computer 300 is transferred to the Content Management Server Computer 200. The Content Compose/Decompose Program 2403 of the Content Management Server Computer 200 divides the content file into multiple sub components as seen in FIG. 21 (decomposition). Header files are stored on SSD 101 A, image files are stored on SAS 101 B, and audio/movie files are stored on SATA drives 101 C. When the Content Reference Server Computer 800 issues a read request to the Content Management Server Computer 200, Content Compose/Decompose Program 2403 looks up the Content Composition Information 2404 to understand which component data to load. It merges and recovers an original content file from components, as seen in FIG. 22 (composition).

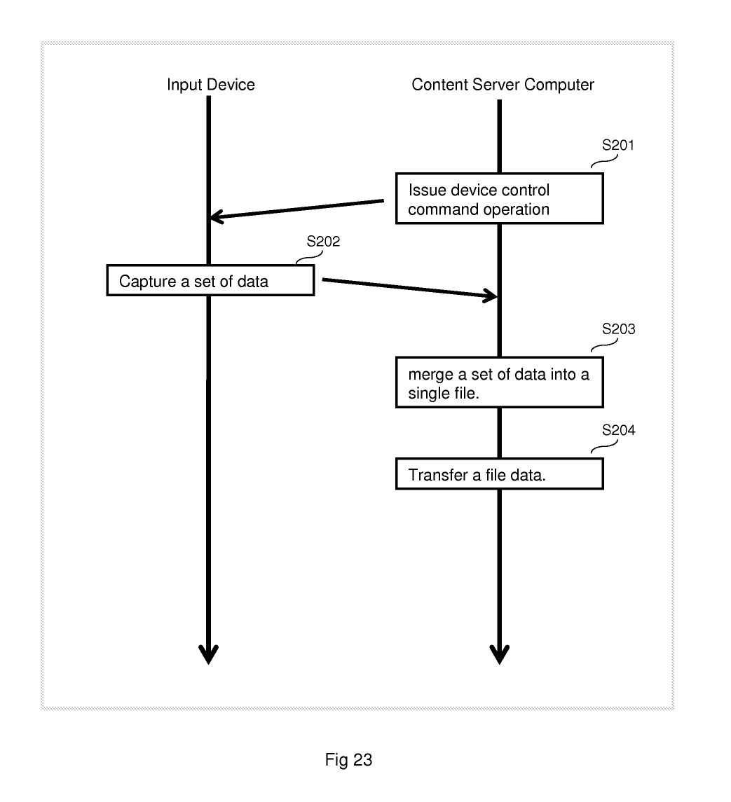

FIG. 23 shows an example of a flow diagram illustrating a process to generate a new content file. The Content Server Computer 300 drives the input device to get new data (S201). The Input Device 400 (e.g., a CT scan device) captures a set of image files with audio and movie (S202). The Content Server Computer 300 composes them into a single DICOM file (S203). It transfers a newly generated data to the Content Management Server Computer 200 (S204).

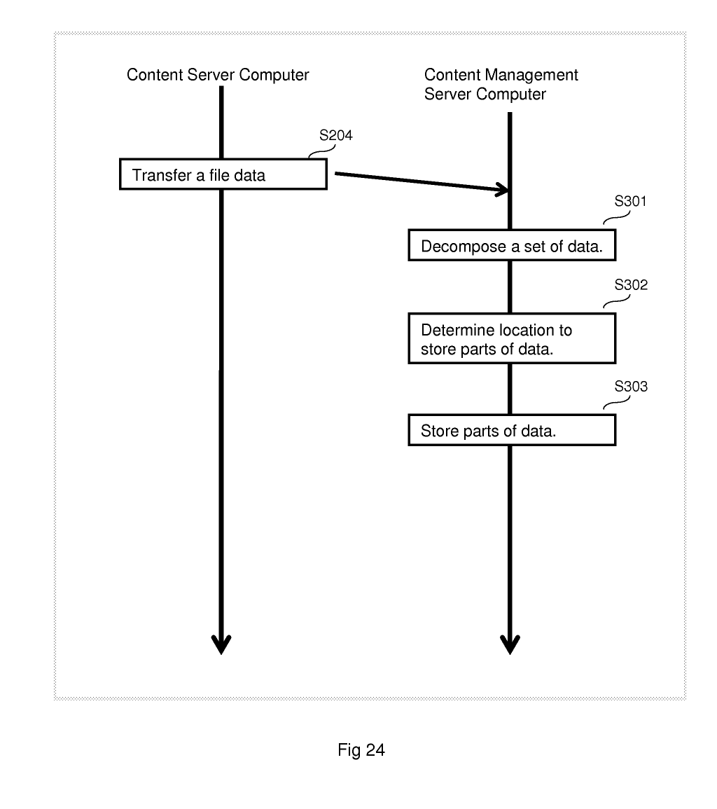

FIG. 24 shows an example of a flow diagram illustrating a process to decompose and store a content file. The Content Server Computer 300 transfers a file data to the Content Management Server Computer 200 (S204). The Content Management Server Computer 200 decomposes a set of data (S301), determines the location to store the parts of data (S302), and stores the parts of data (S303), as seen in FIG. 21 (decomposition).

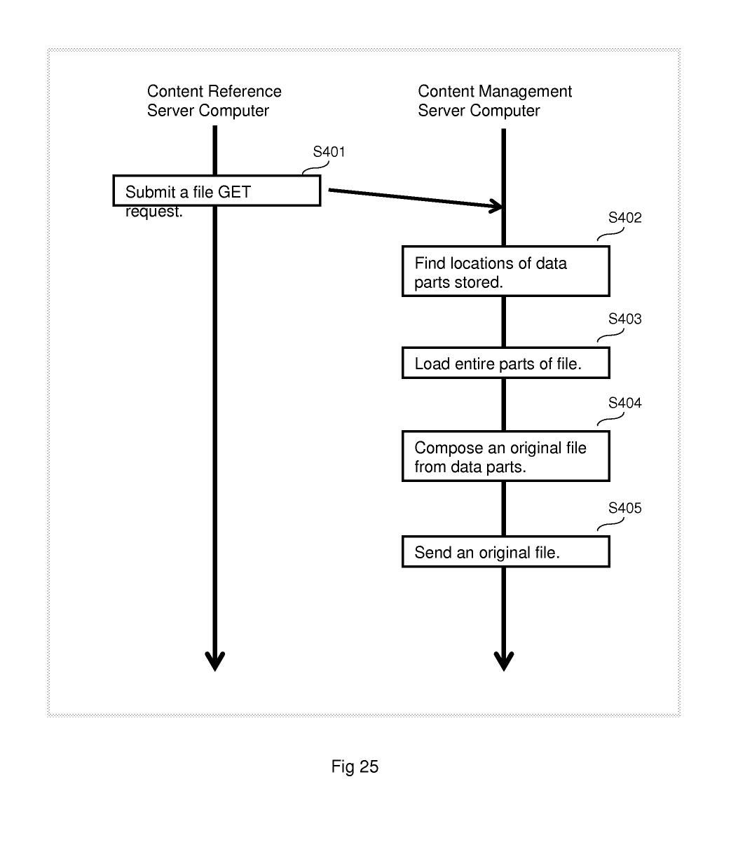

FIG. 25 shows an example of a flow diagram illustrating a process to load and compose a content file. The Content Reference Server Computer 800 submits a file GET request to the Content Management Server Computer 200 (S401). The Content Management Server Computer 200 finds the location of the data parts stored (S402), loads the entire parts of the file (S403), composes an original file from the data parts (S404), and sends an original file (S405).

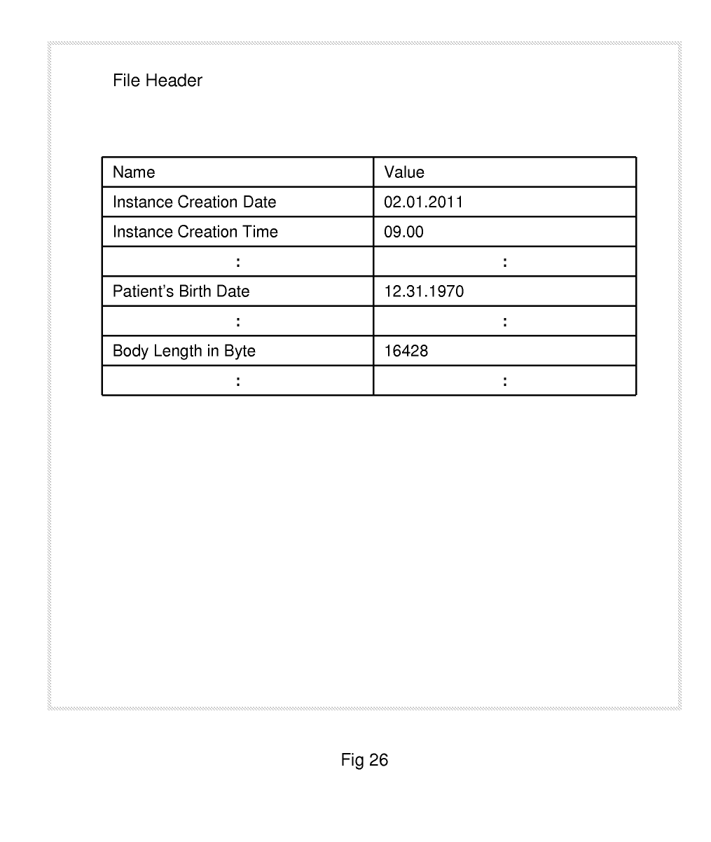

FIG. 26 shows an example of a data structure of the File Header 901. As defined by the DICOM Format Specification, various kinds of information can be recorded on the header part by a combination of Name and Value.

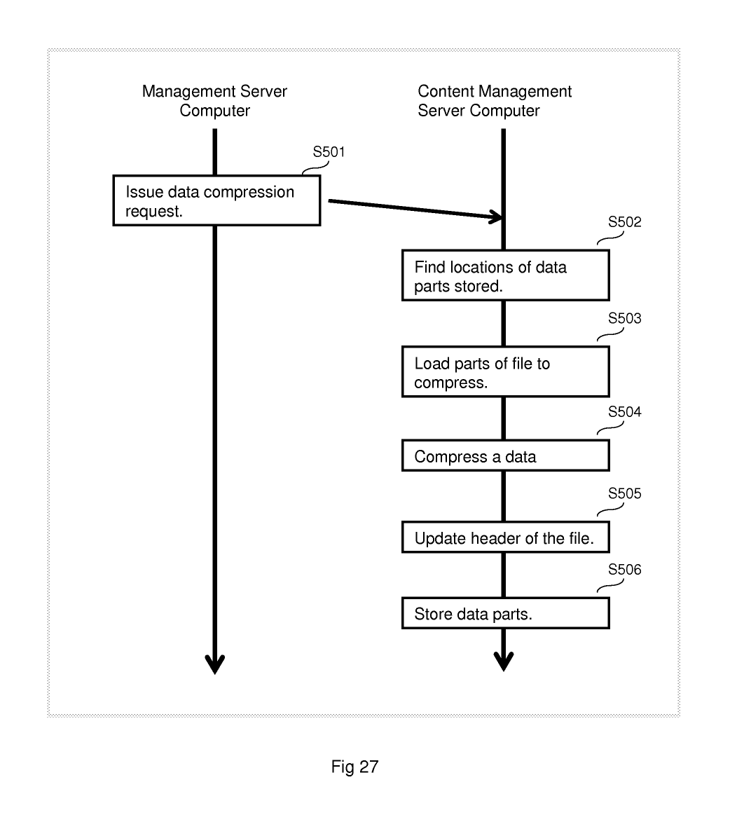

FIG. 27 shows an example of a flow diagram illustrating a process to compress data after it has been stored. The Management Server Computer 500 issues a data compression request by modifying the Compress Information 54024 of the Content Control Policy Definition 5402 (S501). The Content Management Server Computer 200 searches the Content Composition Information 2404 to find fragmented components to compress (S502). It loads fragment parts from the Data Storage 100 (S503) and runs the compression process (S504). It also has to modify a part of the header record which shows a size of body because it can be shortened after compression (S505). After that, the Content Management Server Computer 200 stores the data parts into the original location (S506).

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for efficient data storage for multiple file contents. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A content management computer coupled via a network to a storage system, the content management computer comprising a processor, a memory, and a content compose/decompose module, the content compose/decompose module being configured to:
decompose a file into multiple parts of data and store the multiple parts into adaptive logical storage partitions; and
in response to a read request for the file, re-compose the multiple parts into an original file and send the original file;
wherein the file is decomposed into the multiple parts based on both structure and characteristics of the data in the file; and
wherein the multiple parts are stored into different media provided by the adaptive logical storage partitions according to the structure and characteristics of the data in the multiple parts.

2. The content management computer according to claim 1,
wherein the structure of the data includes a header and a body of the file; and
wherein the characteristics of the data include one or more of text data, image data, audio data, and video data.

3. The content management computer according to claim 1,
wherein decomposing a file comprises dividing the file into a header and a body; and
wherein the header and the body are stored into different media, the header being stored into a higher performance media than the body.

4. The content management computer according to claim 1,
wherein the content compose/decompose module is configured to determine locations to store the multiple parts that are decomposed; and
wherein the content compose/decompose module is configured to find locations of the multiple parts and load the multiple parts that are to be re-composed.

5. The content management computer according to claim 1, further comprising a content compression module configured to:
find fragmented components from the multiple parts that are stored in the adaptive logical storage partitions;
compress the fragmented components;
store the compressed fragmented components; and
update a header of the file based on the compressed fragmented components.

6. The content management computer according to claim 1 further comprising a configuration management module configured to:
detect logical units in the storage system and divide the detected logical units into smaller adaptive logical storage partitions for storing the decomposed multiple parts.

7. An information system comprising a content management computer and a storage system which are coupled via a network, the content management computer including a processor, a memory, and a content compose/decompose module, the content compose/decompose module being configured to:
decompose a file into multiple parts of data and store the multiple parts into adaptive logical storage partitions; and
in response to a read request for the file, re-compose the multiple parts into an original file and send the original file;
wherein the file is decomposed into the multiple parts based on both structure and characteristics of the data in the file; and
wherein the multiple parts are stored into different media provided by the adaptive logical storage partitions according to the structure and characteristics of the data in the multiple parts.

8. The information system according to claim 7,
wherein decomposing a file comprises dividing the file into a header and a body; and
wherein the header and the body are stored into different media, the header being stored into a higher performance media than the body.

9. The information system according to claim 7, further comprising:
a content server computer coupled via the network to the content management computer, the content server computer being configured to merge a set of data from multiple files into a single file and transfer the single file to the content management computer as the file to the decomposed.

10. The information system according to claim 7,
wherein the file is a DICOM file.

11. The information system according to claim 7, wherein the content management computer further comprises a content compression module configured to:
find fragmented components from the multiple parts that are stored in the adaptive logical storage partitions;
compress the fragmented components;
store the compressed fragmented components; and
update a header of the file based on the compressed fragmented components.

12. The information system according to claim 7, wherein the content management computer further comprises a configuration management module configured to:
detect logical units in the storage system and divide the detected logical units into smaller adaptive logical storage partitions for storing the decomposed multiple parts.

13. A content management method for a storage system, the content management method comprising:
decomposing a file into multiple parts of data and storing the multiple parts into adaptive logical storage partitions; and
in response to a read request for the file, re-composing the multiple parts into an original file and send the original file;
wherein the file is decomposed into the multiple parts based on both structure and characteristics of the data in the file; and
wherein the multiple parts are stored into different media provided by the adaptive logical storage partitions according to the structure and characteristics of the data in the multiple parts.

14. The content management method according to claim 13,
wherein the structure of the data includes a header and a body of the file; and
wherein the characteristics of the data include one or more of text data, image data, audio data, and video data.

15. The content management method according to claim 13,
wherein decomposing a file comprises dividing the file into a header and a body; and
wherein the header and the body are stored into different media, the header being stored into a higher performance media than the body.

16. The content management method according to claim 13, further comprising:
determining locations to store the multiple parts that are decomposed; and
finding locations of the multiple parts and loading the multiple parts that are to be re-composed.

17. The content management method according to claim 13, further comprising:
finding fragmented components from the multiple parts that are stored in the adaptive logical storage partitions;
compressing the fragmented components;
storing the compressed fragmented components; and
updating a header of the file based on the compressed fragmented components.

18. The content management method according to claim 13 further comprising:
detecting logical units in the storage system and dividing the detected logical units into smaller adaptive logical storage partitions for storing the decomposed multiple parts.

19. The content management method according to claim 13, further comprising:
merging a set of data from multiple files into a single file and transferring the single file to the content management computer as the file to the decomposed.

20. The content management method according to claim 19,
wherein the file is a DICOM file.
